(19) United States
(12) Patent Application Publication
(10) Pub. No.: US 2025/0365122 A1
(43) Pub. Date: Nov. 27, 2025

(54) SUB-BAND BASED FULL-DUPLEX OPERATION

(71) Applicant: Lenovo (Singapore) Pte. Limited, Singapore (SG)

(72) Inventor: Hyejung Jung, Northbrook, IL (US)

(73) Assignee: Lenovo (Singapore) Pte. Limited, Singapore (SG)

(21) Appl. No.: 18/873,841

(22) PCT Filed: Jun. 8, 2023
(86) PCT No.: PCT/IB2023/055946

§ 371 Date: Dec. 11, 2024

Related U.S. Application Data
(60) Provisional application No. 63/351,673, filed on Jun. 13, 2022.

(51) Int. Cl. H04L 5/14; H04B 17/345; H04L 5/00; H04W 72/541

(52) U.S. Cl. CPC H04L 5/14; H04B 17/345; H04L 5/0094; H04W 72/541

(57) ABSTRACT

Various aspects of the present disclosure relate to methods, apparatuses, and systems that support sub-band based full duplex operation. For instance, a UE is provided with resources for full-duplex UL and DL operation, and a measurement resource that includes multiple time instances for measuring interference in conjunction with full-duplex operation, e.g., CLI. The UE can perform UL transmission on the provided resources and can measure interference using the measurement resource.

### RELATED APPLICATION

This application claims priority to U.S. Patent Application Ser. No. 63/351,673 filed 13 Jun. 2022 entitled “SUB-BAND BASED FULL-DUPLEX OPERATION,” the disclosure of which is incorporated by reference herein in its entirety.

### TECHNICAL FIELD

The present disclosure relates to wireless communications, and more specifically to sub-band operation in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In unpaired spectrum, time division duplex (TDD) can be used to avoid interference (e.g., uplink and downlink interference within a network entity and UE-to-UE interference). However, TDD limits uplink (UL) and downlink (DL) transmission opportunities and makes it difficult to accommodate UL and DL transmissions simultaneously, such as when DL and UL traffics are asymmetric in a cell.

### SUMMARY

The present disclosure relates to methods, apparatuses, and systems that support sub-band based full duplex operation. For instance, a UE is provided with resources for full-duplex UL and DL operation, and a measurement resource that includes multiple time instances for measuring interference in conjunction with full-duplex operation, e.g., cross-link interference (CLI). The UE can perform UL transmission on the provided resources and/or can measure interference using the measurement resource. By performing UL transmission on a full duplex UL sub-band, a UE can reduce transmission latency and increase transmission reliability. Further, by performing interference measurement over multiple time instances based on information of the full duplex UL sub-band, signaling overhead is reduced and the speed with which interference measurement can be performed is increased.

Some implementations of the method and apparatuses described herein may further include receiving, at a UE a semi-static DL and UL configuration; receiving information for a full duplex UL sub-band, the full duplex UL sub-band including a time resource and a frequency resource for UL transmission on symbols configured as one or more of DL symbols or flexible symbols based at least in part on the semi-static DL and UL configuration; and performing interference measurement based on at least part of the information for the full duplex UL sub-band.

In some implementations of the method and apparatuses described herein, the information for the full duplex UL sub-band includes at least a time-domain allocation and a frequency-domain allocation; the information for the full duplex UL sub-band further includes one or more UL configurations, and the one or more UL configurations include at least one of physical uplink shared channel (PUSCH), physical uplink control channel (PUCCH), configured grant (CG) PUSCH, sounding reference signal (SRS), or random access channel (RACH) configuration; the one or more UL configurations are indicated by a bandwidth part identity; subcarrier spacing of the full duplex UL sub-band is further determined based on the bandwidth part identity; a cyclic prefix type of the full duplex UL sub-band is further determined based on the bandwidth part identity; a CLI measurement configuration is received including a CLI resource; performing the interference measurement includes performing the interference measurement on the CLI resource based on a time domain allocation for the full duplex UL sub-band; the CLI measurement configuration includes a plurality of measurement occasions within a measurement periodicity; each of the plurality of measurement occasions corresponds to a set of symbols of a respective measurement slot of a plurality of measurement slots; performing the interference measurement includes performing the interference measurement on the CLI resource based on a frequency domain allocation for the full duplex UL sub-band; one or more resource elements of the CLI resource overlapping in frequency with the full duplex UL sub-band are not included for the interference measurement; the CLI measurement configuration includes a plurality of measurement frequency bands; an interference measurement report is transmitted based at least in part on the interference measurement.

Some implementations of the method and apparatuses described herein may further include receiving, at a UE, a semi-static DL and UL configuration; receiving information for a full duplex UL sub-band, the full duplex UL sub-band including a time resource and a frequency resource for UL transmission on symbols configured as one or more of DL symbols or flexible symbols based at least in part on the semi-static DL and UL configuration; and performing UL transmission on at least part of the full duplex UL sub-band.

In some implementations of the method and apparatuses described herein, the information for the full duplex UL sub-band includes at least a time-domain allocation and a frequency-domain allocation; the information for the full duplex UL sub-band further includes one or more UL configurations, the one or more UL configurations include at least one of PUSCH, PUCCH, CG PUSCH, SRS, or RACH configuration, and the UL transmission is performed based on the one or more UL configurations; the one or more UL configurations are indicated by a bandwidth part identity; subcarrier spacing of the full duplex UL sub-band is further determined based on the bandwidth part identity; a cyclic prefix type of the full duplex UL sub-band is further determined based on the bandwidth part identity; further including receiving a CLI measurement configuration including a CLI resource; interference measurement on the CLI resource is performed based on a time domain allocation for the full duplex UL sub-band; an interference measurement report based is transmitted at least in part on the interference measurement; the CLI measurement configuration includes a plurality of measurement occasions within a measurement periodicity; each of the plurality of measurement occasions corresponds to a set of symbols of a respective measurement slot of a plurality of measurement slots; interference measurement on the CLI resource is performed based on a frequency domain allocation for the full duplex UL sub-band; one or more resource elements of the CLI resource overlapping in frequency with the full duplex UL sub-band are not included for the interference measurement; the CLI measurement configuration includes a plurality of measurement frequency bands.

Some implementations of the method and apparatuses described herein may further include receiving a CLI measurement configuration including a CLI resource, where the CLI resource includes at least one of a plurality of measurement occasions within a measurement periodicity or a plurality of non-contiguous measurement frequency bands; and performing interference measurement on the CLI resource.

In some implementations of the method and apparatuses described herein, an interference measurement report is transmitted based at least in part on the interference measurement.

Some implementations of the method and apparatuses described herein may further include transmitting, to a UE, a semi-static DL and UL configuration; transmitting, to the UE, information for a full duplex UL sub-band, the full duplex UL sub-band including a time resource and a frequency resource for UL transmission on symbols configured as one or more of DL symbols or flexible symbols based at least in part on the semi-static DL and UL configuration; and receiving, from the UE, interference measurement based on at least part of the information for the full duplex UL sub-band.

In some implementations of the method and apparatuses described herein, the information for the full duplex UL sub-band includes at least a time-domain allocation and a frequency-domain allocation; the information for the full duplex UL sub-band further includes one or more UL configurations, and the one or more UL configurations include at least one of PUSCH, PUCCH, CG PUSCH, SRS, or RACH configuration; the one or more UL configurations are indicated by a bandwidth part identity; subcarrier spacing of the full duplex UL sub-band is indicated based at least in part on the bandwidth part identity; a cyclic prefix type of the full duplex UL sub-band is indicated based at least in part on the bandwidth part identity; a CLI measurement configuration is transmitted to a UE including a CLI resource; an instruction is transmitted to a UE to perform interference measurement on the CLI resource based on a time domain allocation for the full duplex UL sub-band; the CLI measurement configuration includes a plurality of measurement occasions within a measurement periodicity; each of the plurality of measurement occasions corresponds to a set of symbols of a respective measurement slot of a plurality of measurement slots; an instruction is transmitted to the UE to perform the interference measurement on the CLI resource based on a time domain allocation for the full duplex UL sub-band; an instruction is transmitted to the UE to perform the interference measurement to not include one or more resource elements of the CLI resource overlapping in frequency with the full duplex UL sub-band; the CLI measurement configuration includes a plurality of measurement frequency bands.

Some implementations of the method and apparatuses described herein may further include transmitting, to a UE, a semi-static DL and UL configuration; transmitting, to the UE, information for a full duplex UL sub-band, the full duplex UL sub-band including a time resource and a frequency resource for UL transmission on symbols configured as one or more of DL symbols or flexible symbols based at least in part on the semi-static DL and UL configuration; and receiving, from the UE, UL transmission on at least part of the full duplex UL sub-band.

In some implementations of the method and apparatuses described herein, the information for the full duplex UL sub-band includes at least a time-domain allocation and a frequency-domain allocation; the information for the full duplex UL sub-band further includes one or more UL configurations, and the one or more UL configurations include at least one of PUSCH, PUCCH, CG PUSCH, SRS, or RACH configuration; the one or more UL configurations are indicated by a bandwidth part identity; subcarrier spacing of the full duplex UL sub-band are indicated based on the bandwidth part identity; a cyclic prefix type of the full duplex UL sub-band is indicated based on the bandwidth part identity; a CLI measurement configuration is transmitted to the UE including a CLI resource; an instruction is transmitted to the UE to perform interference measurement on the CLI resource based on a time domain allocation for the full duplex UL sub-band; the CLI measurement configuration includes a plurality of measurement occasions within a measurement periodicity; each of the plurality of measurement occasions corresponds to a set of symbols of a respective measurement slot of a plurality of measurement slots; an instruction is transmitted to the UE to perform interference measurement on the CLI resource based on a frequency domain allocation for the full duplex UL sub-band; an instruction is transmitted to the UE to exclude, from the interference measurement, resource elements of the CLI resource overlapping in frequency with the full duplex UL sub-band; the CLI measurement configuration includes a plurality of measurement frequency bands.

Some implementations of the method and apparatuses described herein may further include transmitting, to a UE, a CLI measurement configuration including a CLI resource, where the CLI resource includes at least one of a plurality of measurement occasions within a measurement periodicity or a plurality of non-contiguous measurement frequency bands; and receiving, from the UE, an interference measurement report including interference measurement on the CLI resource.

### BRIEF DESCRIPTION OF THE DRAWINGS

FIG. 1 illustrates an example of a wireless communications system that supports sub-band based full-duplex operation in accordance with aspects of the present disclosure.

FIG. 2 illustrates an example of an information element that supports sub-band based full-duplex operation in accordance with aspects of the present disclosure.

FIG. 3 illustrates an example of a full duplex UL sub-band configuration that supports sub-band based full-duplex operation in accordance with aspects of the present disclosure.

FIG. 4 illustrates an example of a full duplex UL sub-band configuration that supports sub-band based full-duplex operation in accordance with aspects of the present disclosure.

FIGS. 5a and 5b illustrate an example of an information element that supports sub-band based full-duplex operation in accordance with aspects of the present disclosure.

FIGS. 6 and 7 illustrate examples of block diagrams of devices that support sub-band based full-duplex operation in accordance with aspects of the present disclosure.

FIGS. 8 through 13 illustrate flowcharts of methods that support sub-band based full-duplex operation in accordance with aspects of the present disclosure.

### DETAILED DESCRIPTION

In some wireless communications systems for unpaired spectrum, TDD is used to avoid interference (e.g. uplink and downlink interference within a network entity and UE-to-UE interference). However, TDD can limit UL and DL transmission opportunities and can result in challenges in accommodating urgent UL and DL transmissions simultaneously, such as when DL and UL traffic is asymmetric in a cell. Further, CLI measurement and reporting mechanisms have been specified to handle co-channel and adjacent channel interference and UE-to-UE interference. However, existing CLI measurement and reporting mechanisms primarily address CLI caused by different TDD UL and DL configurations across neighboring cells and provide limited CLI measurement resources that result in inefficient CLI measurement and increased signaling overhead.

Accordingly, this disclosure provides for configuring a full duplex UL and DL sub-band for full duplex operation in a cell and for measuring cross-link interference with sub-band based full duplex operation, such as where a serving network entity performs simultaneous reception and transmission in non-overlapping sub-bands within a carrier. For instance, a network entity can configure a first sub-band of a carrier as an UL resource and a second sub-band of the carrier not overlapping with the first sub-band as a DL resource for full duplex cell operation within the carrier. A UE can utilize the UL resource and the DL resource as part of sub-band based full-duplex operation. Further, interference measurement is provided for sub-band based full duplex operation such as to implement enhanced time-domain CLI measurement configuration. For example, a UE receives a CLI measurement configuration included in a DL bandwidth part (BWP) configuration, where the CLI measurement configuration configures multiple measurement time instances or measurement occasions (e.g., multiple measurement slots) within a measurement periodicity. The UE can then perform CLI measurement using the multiple time instances, and can generate interference information (e.g., a measurement report) based on the CLI measurement.

Accordingly, by enabling full duplex operation by a network entity and optionally a UE, latency can be reduced by allowing controlled UL and DL transmissions, such as while on-going DL and UL traffic is being served in a carrier. Further, by enabling interference measurement to be performed over multiple time instances based on information of the full duplex UL sub-band, signaling overhead is reduced and the speed with which interference measurement can be performed is increased.

Aspects of the present disclosure are described in the context of a wireless communications system. Aspects of the present disclosure are further illustrated and described with reference to device diagrams and flowcharts.

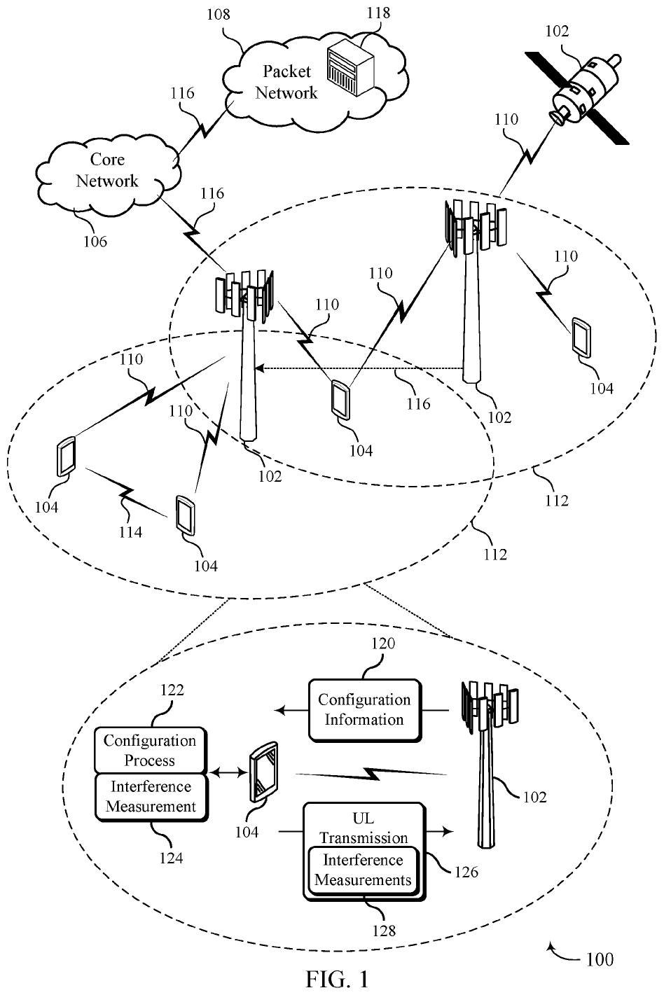

FIG. 1 illustrates an example of a wireless communications system 100 that supports sub-band based full duplex operation in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for sub-band based full-duplex operation, a network entity 102 can transmit configuration information 120 to a UE 104 that includes resources for full-duplex operation, e.g., full-duplex UL and DL operation at least by the network entity 102 and optionally by the UE 104 such as described throughout this disclosure. The configuration information 120 also may include interference measurement configuration, such as a CLI resource for measuring CLI based at least in part on resources provided for full-duplex operation. The UE 104 receives the configuration information 120 and uses the configuration information 120 to perform a configuration process 122 for configuring and performing full-duplex related operation (e.g., full-duplex DL and UL operation, UL transmission on a full duplex UL sub-band, or DL reception on a full duplex DL sub-band) by the UE 104. Further, the UE 104 performs interference measurement 124 (e.g., CLI measurement) using interference configuration received as part of the configuration information 120. Using full-duplex resources provided by the configuration information 120, the UE 104 performs UL transmission 126 to the network entity 102. As part of the UL transmission 126, for example, the UE 104 transmits interference measurements 128 based on the interference measurement 124 to the network entity 102. In at least one implementation, the interference measurements 128 include CLI measurements measured on CLI measurement resources provided by the configuration information 120.

In some wireless communications systems that utilize unpaired spectrum operation, a DL BWP from a set of configured DL BWPs with index provided by BWP-Id for a UE can be linked with an UL BWP from a set of configured UL BWPs with index provided by BWP-Id for the UE, when the DL BWP index and the UL BWP index are same. For unpaired spectrum operation, a UE may not expect to receive a configuration where the center frequency for a DL BWP is different than the center frequency for an UL BWP when the BWP-Id of the DL BWP is same as the BWP-Id of the UL BWP.

Further, for slot formation and configuration, if a UE is provided tdd-UL-DL-ConfigurationDedicated, the parameter tdd-UL-DL-ConfigurationDedicated can override flexible symbols per slot over a number of slots as provided by tdd-UL-DL-ConfigurationCommon. The tdd-UL-DL-ConfigurationDedicated provides:
a set of slot configurations by slotSpecificConfigurationsToAddModList
for each slot configuration from the set of slot configurations
a slot index for a slot provided by slotIndex
a set of symbols for a slot by symbols where
   if symbols=allDownlink, all symbols in the slot are downlink
   if symbols=allUplink, all symbols in the slot are uplink
   if symbols=explicit, nrofDownlinkSymbols provides a number of downlink first symbols in the slot and nrofUplinkSymbols provides a number of uplink last symbols in the slot. If nrofDownlinkSymbols is not provided, there are no downlink first symbols in the slot and if nrofUplinkSymbols is not provided, there are no uplink last symbols in the slot. The remaining symbols in the slot are flexible

Further, if a UE is not configured to monitor PDCCH for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE:
the UE receives PDSCH or CSI-RS in the set of symbols of the slot if the UE receives a corresponding indication by a DCI format
the UE transmits PUSCH, PUCCH, PRACH, or SRS in the set of symbols of the slot if the UE receives a corresponding indication by a DCI format, a RAR UL grant, fallbackRAR UL grant, or successRAR

For a set of symbols of a slot that are indicated to a UE as flexible by tdd-UL-DL-ConfigurationCommon, and tdd-UL-DL-ConfigurationDedicated if provided, the UE may not expect to receive both dedicated higher layer parameters configuring transmission from the UE in the set of symbols of the slot and dedicated higher layer parameters configuring reception by the UE in the set of symbols of the slot.

In some wireless communications systems that implement CLI measurement, two types of CLI measurements, SRS reference signal received power (SRS-RSRP) and CLI reference signal strength indicator (CLI-RSSI) have been specified. SRS-RSRP has been defined as linear average of power contributions (e.g., in Watt) of resource elements carrying SRS. Further, SRS-RSRP can be measured over configured resource elements within a considered measurement frequency bandwidth in configured measurement time occasions. CLI-RSSI can be defined as linear average of the total received power (e.g., in Watt) observed in configured OFDM symbols of a configured measurement time resource(s), in a configured measurement bandwidth from all sources, such as including co-channel serving and non-serving cells, adjacent channel interference, thermal noise, etc. For instance, for FR1, a reference point for measurements can be an antenna connector of a UE. For FR2, the measurements can be done based on combined signal from antenna elements corresponding to a given receiver branch. For FR1 and FR2, if receiver diversity is in use by a UE, a reported measurement value can have a lower bound defined by the corresponding measurement value of any of the individual receiver branches.

SRS resources configured for SRS-RSRP measurement for CLI in a DL BWP may include subcarrier spacing that is the same as subcarrier spacing of the DL BWP. A UE may not be expected to measure SRS-RSRP using a SRS-RSRP measurement resource which is not fully confined within the DL BWP. Further, the UE may not be expected to measure more than 32 SRS resources, and the UE may not be expected to receive more than 8 SRS resources in a slot.

To assist with interference handling such as self-interference and cross-link interference (e.g. UE-to-UE, base station (BS)-to-BS), sub-band based full duplex operation (i.e. one sub-band of a carrier serves UL traffics and another sub-band of the carrier serves DL traffics) in unpaired spectrum can be implemented. Accordingly, this disclosure discusses configuring a full duplex UL and DL sub-band for full duplex operation in a cell and measuring cross-link interference with sub-band based full duplex operation, such as where a serving network entity performs simultaneous reception and transmission in non-overlapping sub-bands within a carrier. For instance, when a network entity (e.g., gNB) is capable of simultaneous reception and transmission (e.g., capable of full duplexing with a certain level of self-interference suppression) within a carrier, the network entity can configure a first sub-band of a carrier as an UL resource and a second sub-band of the carrier not overlapping with the first sub-band as a DL resource for full duplex cell operation within the carrier at least for a certain duration.

For instance, for sub-band configuration for sub-band based full duplex operation, a UE receives information of a time resource and a frequency resource (e.g., full duplex UL sub-band) for UL transmission on symbols configured as DL and/or flexible symbols, and/or a time resource and/or a frequency resource (e.g., full duplex DL sub-band) for DL reception on symbols configured as UL or flexible symbols. The sub-band configuration can optionally include information of guard bands around the full duplex sub-band. The configuration of symbols as DL, UL, and/or flexible symbols, for instance, is provided by tdd-UL-DL-ConfigurationCommon and additionally by tdd-IL-DL-ConfigurationDedicated, if configured. Information of full duplex UL sub-band and/or full duplex DL sub-band can be signaled as part of system information in a system information block (SIB) and/or in a dedicated RRC message.

In at least one an implementation, information of full duplex UL sub-band and/or full duplex DL sub-band includes one or more of frequency domain location, time domain allocation, subcarrier spacing, a cyclic prefix (CP) type, and uplink configurations such as PUSCH, PUCCH, RACH configuration, CG-PUSCH, etc. Further, information of full duplex UL sub-band and/or full duplex DL sub-band can include SRS configurations for the UL sub-band or downlink configurations such as PDSCH, PDCCH, and/or semi-persistent scheduling (SPS) configurations for the DL sub-band. In at least one example, UL and/or DL configurations of the full duplex UL and/or DL sub-band can be provided by a BWP identity, where a UE determines the UL and/or DL configurations from configurations of a UL and/or DL BWP indicated by the BWP identity. A UE may assume the subcarrier spacing and the CP type for the full duplex UL and/or DL sub-band are the same as subcarrier spacing and CP type of the indicated UL and/or DL BWP, such as when the subcarrier spacing and the CP type are not separately configured for the full duplex UL and/or DL sub-band.

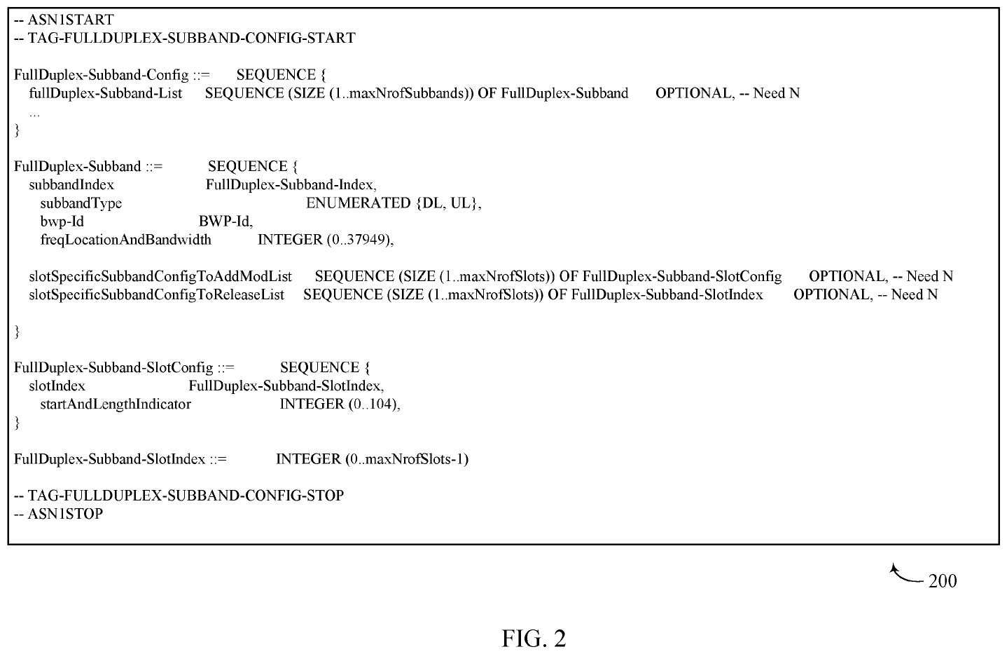

FIG. 2 illustrates an example FullDuplex-Subband-Config Information Element (IE) 200 that supports sub-band based full-duplex operation in accordance with aspects of the present disclosure. The IE 200, for instance, can used to configure a list of full duplex UL and/or DL sub-bands (e.g., FullDuplex-Subband) for a UE and/or in a cell. The IE 200 includes different fields some of which are detailed in Table 1:

TABLE 1
slotSpecificSubbandConfigToAddModList
The slotSpecificSubbandConfigToAddModList defines a list of slot-specific time-domain
allocations for this full duplex sub-band.
startAndLengthIndicator
Start and length indicator value indicating the number of consecutive symbols L counting
from the starting symbol S allocated for this full duplex sub-band within a slot.
slotIndex
Identifies a slot within a slot configuration period given in tdd-UL-DL-
configurationCommon (i.e. cell-specific TDD UL/DL configuration)
subbandIndex
An identifier for this full duplex sub-band (e.g. an index within a cell, within a UE, or
within a BWP)
subbandType
Indicating an UL full duplex sub-band or a DL full duplex sub-band
bwp-Id
An identifier for a bandwidth part associated with this full duplex sub-band, where
configuration (except for frequency domain location) of the bandwidth part is applied to
this full duplex sub-band. For an UL full duplex sub-band, the BWP-Id refers to an UL
BWP, and for a DL full duplex sub-band, the BWP-Id refers to a DL BWP.
freqLocationAndBandwidth
Frequency domain location and bandwidth of this full duplex sub-band. The value of the
field can be interpreted as resource indicator value (RIV), i.e. setting N_{BWP}^{size} = 275. The
first physical resource block (PRB) is a PRB determined by subcarrierSpacing of this
full duplex sub-band and offsetToCarrier (configured in SCS-SpecificCarrier contained
within FrequencyInfoDL/FrequencyInfoUL/FrequencyInfoUL-SIB/
FrequencyInfoDL-SIB within ServingCellConfigCommon/
ServingCellConfigCommonSIB) corresponding to this subcarrier.

In at least one implementation, from the parameter startAndlengthIndicator indicating a start and length indicator value (SLIV), a number of consecutive symbols L counting from a starting symbol S allocated for a full duplex sub-band within a slot is determined as follows:

$$if ( L - 1 ) \leq 7 then$$

$$SLIV = 14 \cdot ( L - 1 ) + S$$

$$else$$

$$SLIV = 14 \cdot ( 14 - L + 1 ) + ( 14 - 1 - S )$$

$$where 0 < L \leq 14 - S .$$

In at least one implementation, a resource indication value (RIV) corresponding to a starting virtual resource block (RBₛₜₐᵣₜ) and a length in terms of contiguously allocated resource blocks L_{RBs} is defined by:

$$if ( {L}_{RBs} - 1 ) \leq ⌊ {N}_{BWP}^{size} / 2 ⌋ then$$

$$RIV = {N}_{BWP}^{size} ( {L}_{RBs} - 1 ) + {RB}_{start}$$

$$else$$

$$RIV = {N}_{BWP}^{size} ( {N}_{BWP}^{size} - {L}_{RBs} + 1 ) + ( {N}_{BWP}^{size} - 1 - {RB}_{start} )$$

$$where {L}_{RBs} \geq 1 and shall not exceed {N}_{BWP}^{size} - {RB}_{start} .$$

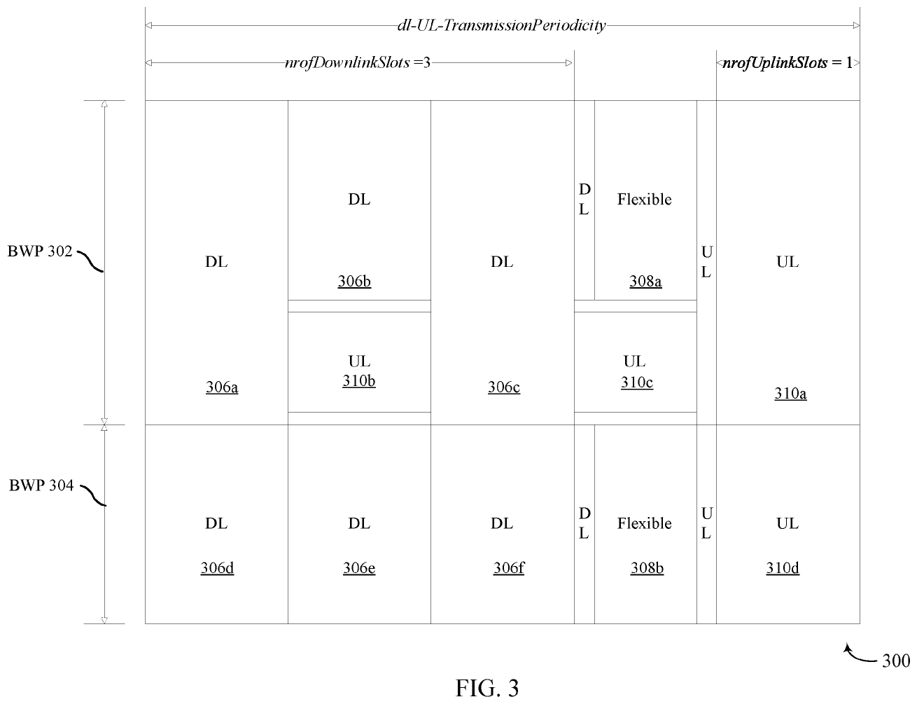

FIG. 3 illustrates an example full duplex UL sub-band configuration 300 that supports sub-band based full-duplex operation in accordance with aspects of the present disclosure. A network, for example, can configure a UE 104 with the UL sub-band configuration 300 using the IE 200. In this example, the UL sub-band configuration 300 is configured in 2 slots within every 5 slots, e.g., a DL-UL pattern of periodicity of 5 slots. The UL sub-band configuration 300 includes a BWP 302 and a BWP 304. Within the BWP 302 the UL sub-band configuration 300 includes a DL sub-band 306a, a DL sub-band 306b, a DL sub-band 306c, a DL sub-band 306d, a flexible sub-band 308a, and an UL sub-band 310a. Within the DL sub-band 306b the UL sub-band configuration 300 is configured with a full-duplex UL sub-band 310b and within the flexible sub-band 308a the UL sub-band configuration 300 is configured with a full-duplex UL sub-band 310c. Within the BWP 304 the full duplex UL sub-band configuration 300 includes a DL sub-band 306d, a DL sub-band 306e, a DL sub-band 306f, a flexible sub-band 308b, and an UL sub-band 310d. In implementations, a UE can utilize the UL sub-bands 310b, 310c as part of sub-band based full-duplex operation.

This disclosure also provides interference measurement for sub-band based full duplex operation such as to implement enhanced time-domain CLI measurement configuration. For example, a UE receives a cross-link CLI measurement configuration included in a DL BWP configuration, where the CLI measurement configuration configures multiple measurement time instances or measurement occasions (e.g., multiple measurement slots) within a measurement periodicity.

In at least one implementation, multiple CLI measurement slots configured within a measurement periodicity have the same configuration for measurement symbols, e.g. a starting symbol and the number of symbols within a slot for measurement. Alternatively or additionally, each of multiple CLI measurement slots configured within a measurement periodicity have a separate configuration for measurement symbols, e.g. a starting symbol and the number of symbols within a slot for measurement.

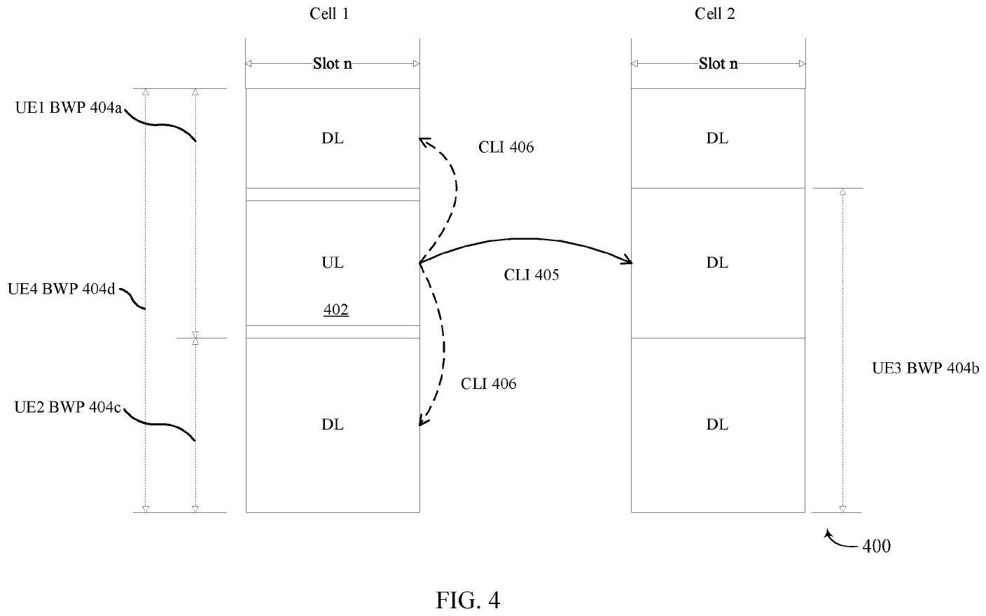

FIG. 4 illustrates an example full duplex UL sub-band configuration 400 that supports sub-band based full-duplex operation in accordance with aspects of the present disclosure. In the UL sub-band configuration 400 a full duplex UL sub-band 402 is configured within a bandwidth of an active DL BWP 404a of a UE1 in a Cell 1 and a DL BWP 404b of a UE3 in a Cell 2, where the active DL BWP 404b of UE3 overlaps in frequency with the full duplex UL sub-band 402 and can be configured to measure intra-sub-band UE-to-UE CLI 405 caused by UL transmission in the full duplex UL sub-band 402 in Cell 1. For instance, the full duplex UL sub-band 402 can be configured on multiple slots within a periodicity of a DL-UL pattern (e.g., provided by tdd-UL-DL-ConfigurationCommon) and can be used to perform CLI measurements on the multiple slots within the periodicity of the DL-UL pattern. This configuration allows faster measurement and reporting, and thus time-domain CLI measurement configuration can be enhanced to configure multiple measurement slots within a measurement periodicity.

In at least one implementation, a UE receives a full duplex UL sub-band configuration including time domain allocation information for a cell and further receives a CLI measurement configuration/indication without time domain information (e.g., periodicity, slot offset, a starting symbol, and/or the number of symbols within a slot) for a CLI resource in the cell. The UE can perform CLI measurement on the CLI resource based on the time domain allocation for the full duplex UL sub-band.

In at least one implementation, an RSSI-CLI resource in time domain is determined according to the parameter startAndLengthIndicator (e.g., start and length indicator value (SLIV)) for each full duplex UL sub-band slot of a configured full duplex UL sub-band. In the full duplex UL sub-band configuration 400, since the full duplex UL sub-band 402 is within a bandwidth of the active DL BWP 404a of UE1 and an active DL BWP 404c of a UE2 is adjacent to the full duplex UL sub-band 402 in Cell 1, UE1 or UE2 may be configured to measure inter-sub-band UE-to-UE CLI 406 caused by UL transmission in the full duplex UL sub-band 402. Similar to intra-sub-band CLI measurement of the CLI 405, UE1 or UE2 can be configured with multiple measurement slots within a measurement periodicity, which can be dependent on time domain configuration of the full duplex UL sub-band 402 in cell 1. Alternatively or additionally, a CLI measurement configuration for UE1 or UE2 in Cell 1 may not have a separate time-domain configuration (or only includes partial time-domain configuration such as a measurement periodicity) for a CLI resource (e.g., a RSSI resource or SRS resource) and can perform CLI measurement according to time domain configuration information of the full duplex UL sub-band, e.g., by performing measurements on slots configured with the full duplex UL sub-band 402.

In implementations, non-contiguous CLI measurement bandwidth is provided. For instance, a UE receives the configuration of the full duplex UL sub-band 402 and when a CLI resource is configured in a cell with a CLI measurement bandwidth including at least one resource element of the full duplex UL sub-band 402 of the Cell 1, the UE performs measurements on the CLI resource excluding one or more resource elements of the CLI resource overlapping with the full duplex UL sub-band 402.

Alternatively or additionally, a UE receives measurement bandwidth information for a CLI resource including a plurality of measurement bandwidths that are not contiguous. In at least one implementation, each measurement bandwidth information comprises a starting PRB and the number of contiguous PRBs. For instance, in the full duplex UL sub-band configuration 400, since the full duplex UL sub-band 402 is within a bandwidth of an active DL BWP 404d of a UE4, two CLI measurement bandwidths for a CLI resource can be configured in a non-contiguous manner such that the full duplex UL sub-band 402 is excluded from the two CLI measurement bandwidths. Alternatively or additionally, one CLI measurement bandwidth is configured for the CLI resource and a UE performs CLI measurements on resource elements of the CLI resource not overlapping with the full duplex UL sub-band 402.

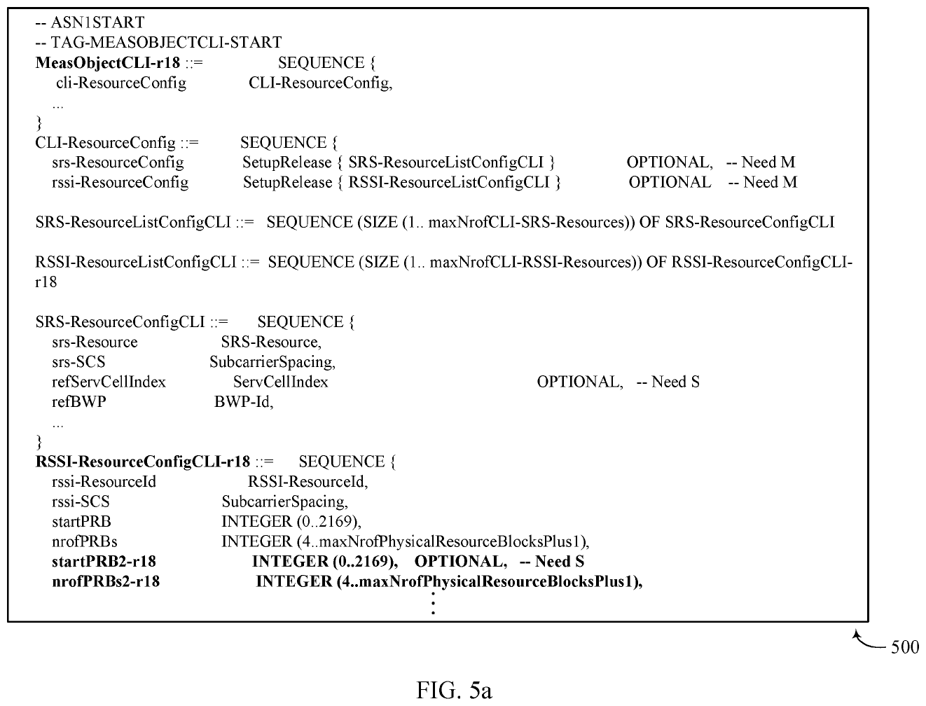

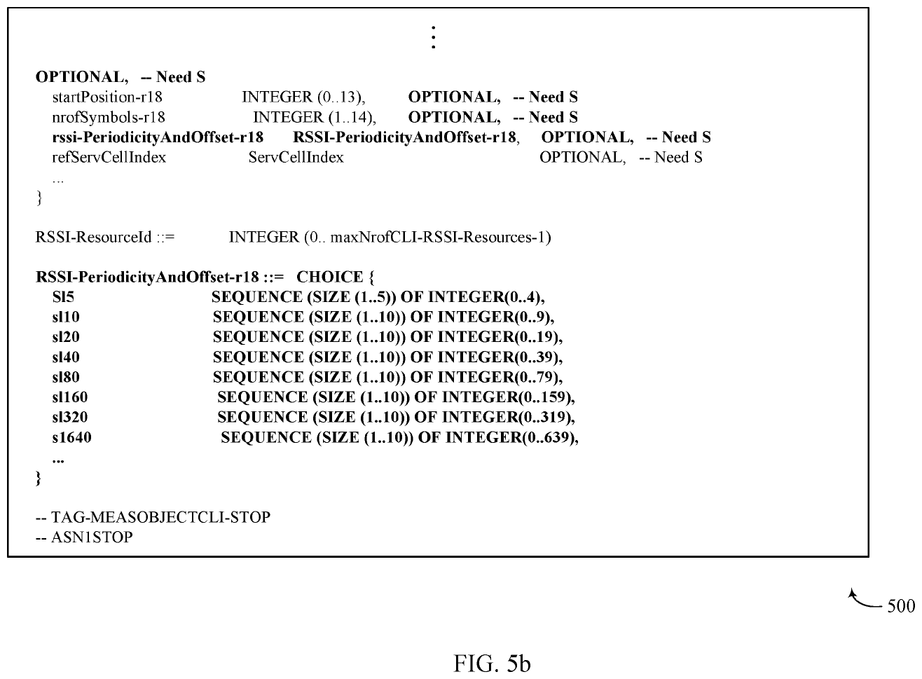

FIGS. 5a and 5b illustrate an example MeasObjectCLI IE 500 that supports sub-band based full-duplex operation in accordance with aspects of the present disclosure. In at least some implementations, portions of the IE 500 in FIGS. 5a and 5b can be combined into a single integrated IE or can be communicated via separate IEs. The IE 500, for instance, is applicable for specifying information for SRS-RSRP measurements and/or CLI-RSSI measurements. Further, the IE 500 can used to configure two measurement bandwidths, such as using parameters startPRB, nrofPRBs, startPRB2-r18, and nrofPRBs2-r18 and can be used to configure multiple measurement slots within a measurement periodicity such as via parameter RSSI-PeriodicityAndOffset-r18. The IE 500 includes a SRS-ResourceConfigCLI portion (parameters described in Table 2a) which can be used to configure SRS resources to be used for CLI measurements, and an RSSI-ResourceConfig portion (parameters described in Table 2b) which can be used to configure CLI-RSSI resources to be used for CLI measurements.

TABLE 2a
SRS-ResourceConfigCLI field descriptions

refBWP
DL BWP id that is used to derive the reference point of the SRS resource
refServCellIndex
The index of the reference serving cell that the refBWP belongs to. If this
field is absent, the reference serving cell is PCell.
srs-SCS
Subcarrier spacing for SRS. Only the values 15, 30 kHz or 60 kHz (FR1),
and 60 or 120 kHz (FR2) are applicable.

TABLE 2b
RSSI-ResourceConfigCLI field descriptions

nrofPRBs, nrofPRBs2
Allowed size of the measurement BW. In some implementations only multiples of 4 are
allowed and the smallest configurable number is the minimum of 4 and the width of the
active DL BWP. If the configured value is larger than the width of the active DL BWP,
the UE can assume that the actual CLI-RSSI resource bandwidth is within the active DL
BWP.
nrofSymbols
Within a slot that is configured for CLI-RSSI measurement (see slotConfiguration), the
UE measures the RSSI from startPosition to startPosition + nrofSymbols − 1. The
configured CLI-RSSI resource may not exceed the slot boundary of the reference SCS. If
the SCS of configured DL BWP(s) is larger than the reference SCS, network configures
startPosition and nrofSymbols such that the configured CLI-RSSI resource is not to
exceed the slot boundary corresponding to the configured BWP SCS. If the reference
SCS is larger than SCS of configured DL BWP(s), network ensures startPosition and
nrofSymbols are integer multiple of reference SCS divided by configured BWP SCS.
refServCellIndex
The index of the reference serving cell. Frequency reference point of the RSSI resource
is subcarrier 0 of CRB0 of the reference serving cell. If this field is absent, the reference
serving cell is PCell.
rssi-PeriodicityAndOffset
Periodicity and slot offset for this CLI-RSSI resource. All values are in “number of
slots”. Value sl1 corresponds to a periodicity of 1 slot, value sl2 corresponds to a
periodicity of 2 slots, and so on. For each periodicity the corresponding one or more
offsets are given in number of slots.
rssi-SCS
Reference subcarrier spacing for CLI-RSSI measurement. In at least some
implementations only the values 15, 30 kHz or 60 kHz (FR1), and 60 or 120 kHz (FR2)
are applicable. In at least some implementations a UE performs CLI-RSSI measurement
with the SCS of the active bandwidth part within the configured CLI-RSSI resource in
the active BWP regardless of the reference SCS of the measurement resource.
startPosition
OFDM symbol location of the CLI-RSSI resource within a slot.
startPRB, startPRB2
Starting PRB index of the measurement bandwidth. For the case where the reference
subcarrier spacing is smaller than subcarrier spacing of active DL BWP(s), network
configures startPRB/startPRB2 and nrofPRBs/nrofPRBs2 are as a multiple of active
BW SCS divided by reference SCS.

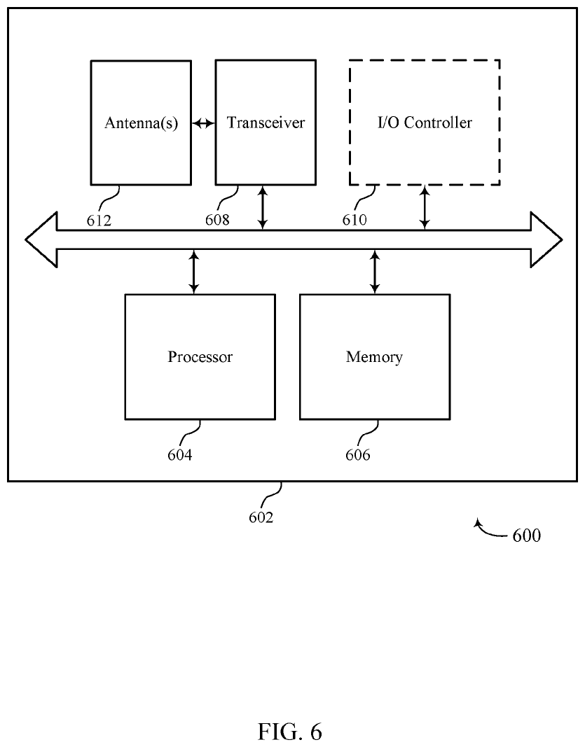

FIG. 6 illustrates an example of a block diagram 600 of a device 602 (e.g., an apparatus) that supports sub-band based full duplex operation in accordance with aspects of the present disclosure. The device 602 may be an example of UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606). In the context of UE 104, for example, the transceiver 608 and the processor coupled 604 coupled to the transceiver 608 are configured to cause the UE 104 to perform the various described operations and/or combinations thereof.

For example, the processor 604 and/or the transceiver 608 may support wireless communication at the device 602 in accordance with examples as disclosed herein. For instance, the processor 604 and/or the transceiver 608 may be configured as or otherwise support a means for receiving, at a UE, a semi-static DL and UL configuration; receiving information for a full duplex UL sub-band, the full duplex UL sub-band including a time resource and a frequency resource for UL transmission on symbols configured as one or more of DL symbols or flexible symbols based at least in part on the semi-static DL and UL configuration; and performing interference measurement based on at least part of the information for the full duplex UL sub-band.

Further, in some implementations, the information for the full duplex UL sub-band includes at least a time-domain allocation and a frequency-domain allocation; the information for the full duplex UL sub-band further includes one or more UL configurations, and the one or more UL configurations include at least one of PUSCH, PUCCH, CG PUSCH, SRS, or RACH configuration; the one or more UL configurations are indicated by a bandwidth part identity; subcarrier spacing of the full duplex UL sub-band is further determined based on the bandwidth part identity; a cyclic prefix type of the full duplex UL sub-band is further determined based on the bandwidth part identity; a CLI measurement configuration is received including a CLI resource; performing the interference measurement includes performing the interference measurement on the CLI resource based on a time domain allocation for the full duplex UL sub-band; the CLI measurement configuration includes a plurality of measurement occasions within a measurement periodicity; each of the plurality of measurement occasions corresponds to a set of symbols of a respective measurement slot of a plurality of measurement slots; performing the interference measurement includes performing the interference measurement on the CLI resource based on a frequency domain allocation for the full duplex UL sub-band; one or more resource elements of the CLI resource overlapping in frequency with the full duplex UL sub-band are not included for the interference measurement; the CLI measurement configuration includes a plurality of measurement frequency bands; an interference measurement report is transmitted based at least in part on the interference measurement.

In a further example, the processor 604 and/or the transceiver 608 may support wireless communication at the device 602 in accordance with examples as disclosed herein. The processor 604 and/or the transceiver 608, for instance, may be configured as or otherwise support a means for receiving, at a UE, a semi-static DL and UL configuration; receiving information for a full duplex UL sub-band, the full duplex UL sub-band including a time resource and a frequency resource for UL transmission on symbols configured as one or more of DL symbols or flexible symbols based at least in part on the semi-static DL and UL configuration; and performing UL transmission on at least part of the full duplex UL sub-band.

Further, in some implementations, the information for the full duplex UL sub-band includes at least a time-domain allocation and a frequency-domain allocation; the information for the full duplex UL sub-band further includes one or more UL configurations, the one or more UL configurations include at least one of PUSCH, PUCCH, CG PUSCH, SRS, or RACH configuration, and the UL transmission is performed based on the one or more UL configurations; the one or more UL configurations are indicated by a bandwidth part identity; subcarrier spacing of the full duplex UL sub-band is further determined based on the bandwidth part identity; a cyclic prefix type of the full duplex UL sub-band is further determined based on the bandwidth part identity; further including receiving a CLI measurement configuration including a CLI resource; interference measurement on the CLI resource is performed based on a time domain allocation for the full duplex UL sub-band; an interference measurement report based is transmitted at least in part on the interference measurement; the CLI measurement configuration includes a plurality of measurement occasions within a measurement periodicity; each of the plurality of measurement occasions corresponds to a set of symbols of a respective measurement slot of a plurality of measurement slots; interference measurement on the CLI resource is performed based on a frequency domain allocation for the full duplex UL sub-band; one or more resource elements of the CLI resource overlapping in frequency with the full duplex UL sub-band are not included for the interference measurement; the CLI measurement configuration includes a plurality of measurement frequency bands.

In a further example, the processor 604 and/or the transceiver 608 may support wireless communication at the device 602 in accordance with examples as disclosed herein. The processor 604 and/or the transceiver 608, for instance, may be configured as or otherwise support a means for receiving a CLI measurement configuration including a CLI resource, where the CLI resource includes at least one of a plurality of measurement occasions within a measurement periodicity or a plurality of non-contiguous measurement frequency bands; and performing interference measurement on the CLI resource.

Further, in some implementations, an interference measurement report is transmitted based at least in part on the interference measurement.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor M06. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

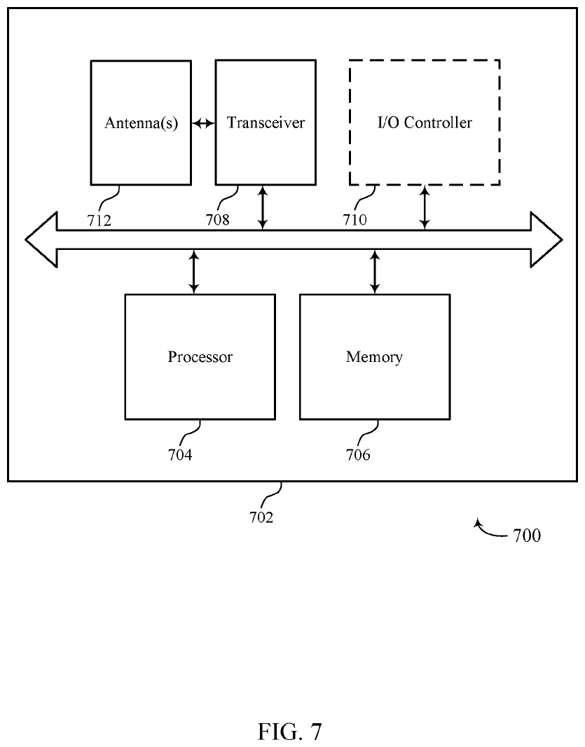

FIG. 7 illustrates an example of a block diagram 700 of a device 702 (e.g., an apparatus) that supports sub-band based full duplex operation in accordance with aspects of the present disclosure. The device 702 may be an example of a network entity 102 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of network entity 102, for example, the transceiver 708 and the processor 704 coupled to the transceiver 708 are configured to cause the network entity 102 to perform the various described operations and/or combinations thereof.

For example, the processor 704 and/or the transceiver 708 may support wireless communication at the device 702 in accordance with examples as disclosed herein. The processor 704 and/or the transceiver 708, for instance, may be configured as or otherwise support a means for transmitting, to a UE, a semi-static DL and UL configuration; transmitting, to the UE, information for a full duplex UL sub-band, the full duplex UL sub-band including a time resource and a frequency resource for UL transmission on symbols configured as one or more of DL symbols or flexible symbols based at least in part on the semi-static DL and UL configuration; and receiving, from the UE, interference measurement based on at least part of the information for the full duplex UL sub-band.

Further, in some implementations, the information for the full duplex UL sub-band includes at least a time-domain allocation and a frequency-domain allocation; the information for the full duplex UL sub-band further includes one or more UL configurations, and the one or more UL configurations include at least one of PUSCH, PUCCH, CG PUSCH, SRS, or RACH configuration; the one or more UL configurations are indicated by a bandwidth part identity; subcarrier spacing of the full duplex UL sub-band is indicated based at least in part on the bandwidth part identity; a cyclic prefix type of the full duplex UL sub-band is indicated based at least in part on the bandwidth part identity; a CLI measurement configuration is transmitted to a UE including a CLI resource; an instruction is transmitted to a UE to perform interference measurement on the CLI resource based on a time domain allocation for the full duplex UL sub-band; the CLI measurement configuration includes a plurality of measurement occasions within a measurement periodicity; each of the plurality of measurement occasions corresponds to a set of symbols of a respective measurement slot of a plurality of measurement slots; an instruction is transmitted to the UE to perform the interference measurement on the CLI resource based on a time domain allocation for the full duplex UL sub-band; an instruction is transmitted to the UE to perform the interference measurement to not include one or more resource elements of the CLI resource overlapping in frequency with the full duplex UL sub-band; the CLI measurement configuration includes a plurality of measurement frequency bands.

In a further example, the processor 704 and/or the transceiver 708 may be configured as or otherwise support a means for transmitting, to a UE, a semi-static DL and UL configuration; transmitting, to the UE, information for a full duplex UL sub-band, the full duplex UL sub-band including a time resource and a frequency resource for UL transmission on symbols configured as one or more of DL symbols or flexible symbols based at least in part on the semi-static DL and UL configuration; and receiving, from the UE, UL transmission on at least part of the full duplex UL sub-band.

Further, in some implementations, the information for the full duplex UL sub-band includes at least a time-domain allocation and a frequency-domain allocation; the information for the full duplex UL sub-band further includes one or more UL configurations, and the one or more UL configurations include at least one of PUSCH, PUCCH, CG PUSCH, SRS, or RACH configuration; the one or more UL configurations are indicated by a bandwidth part identity; subcarrier spacing of the full duplex UL sub-band are indicated based on the bandwidth part identity; a cyclic prefix type of the full duplex UL sub-band is indicated based on the bandwidth part identity; a CLI measurement configuration is transmitted to the UE including a CLI resource; an instruction is transmitted to the UE to perform interference measurement on the CLI resource based on a time domain allocation for the full duplex UL sub-band; the CLI measurement configuration includes a plurality of measurement occasions within a measurement periodicity; each of the plurality of measurement occasions corresponds to a set of symbols of a respective measurement slot of a plurality of measurement slots; an instruction is transmitted to the UE to perform interference measurement on the CLI resource based on a frequency domain allocation for the full duplex UL sub-band; an instruction is transmitted to the UE to exclude, from the interference measurement, resource elements of the CLI resource overlapping in frequency with the full duplex UL sub-band; the CLI measurement configuration includes a plurality of measurement frequency bands.

In a further example, the processor 704 and/or the transceiver 708 may be configured as or otherwise support a means for transmitting, to a UE, a CLI measurement configuration including a CLI resource, where the CLI resource includes at least one of a plurality of measurement occasions within a measurement periodicity or a plurality of non-contiguous measurement frequency bands; and receiving, from the UE, an interference measurement report including interference measurement on the CLI resource.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M06. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

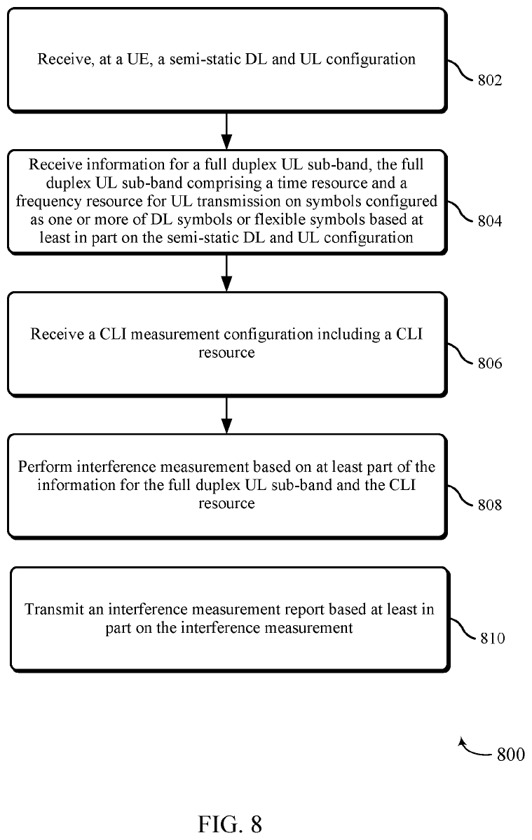

FIG. 8 illustrates a flowchart of a method 800 that supports sub-band based full duplex operation in accordance with aspects of the present disclosure. The operations of the method 800 may be implemented by a device or its components as described herein. For example, the operations of the method 800 may be performed by a UE 104 as described with reference to FIGS. 1 through 5b. In some implementations, the device may execute a set of instructions to control the function elements of the device to perform the described functions. Additionally, or alternatively, the device may perform aspects of the described functions using special-purpose hardware.

At 802, the method may include receiving, at a UE, a semi-static DL and UL configuration. The operations of 802 may be performed in accordance with examples as described herein. In some implementations, aspects of the operations of 802 may be performed by a device as described with reference to FIG. 1.

At 804, the method may include receiving information for a full duplex UL sub-band, the full duplex UL sub-band comprising a time resource and a frequency resource for UL transmission on symbols configured as one or more of DL symbols or flexible symbols based at least in part on the semi-static DL and UL configuration. The operations of 804 may be performed in accordance with examples as described herein. In some implementations, aspects of the operations of 804 may be performed by a device as described with reference to FIG. 1.

At 806, the method may include receiving a CLI measurement configuration including a CLI resource. The operations of 806 may be performed in accordance with examples as described herein. In some implementations, aspects of the operations of 806 may be performed by a device as described with reference to FIG. 1.

At 808, the method may include performing interference measurement based on at least part of the information for the full duplex UL sub-band and the CLI resource. The operations of 808 may be performed in accordance with examples as described herein. In some implementations, aspects of the operations of 808 may be performed by a device as described with reference to FIG. 1.

At 810, the method may include transmitting an interference measurement report based at least in part on the interference measurement. The operations of 810 may be performed in accordance with examples as described herein. In some implementations, aspects of the operations of 810 may be performed by a device as described with reference to FIG. 1.

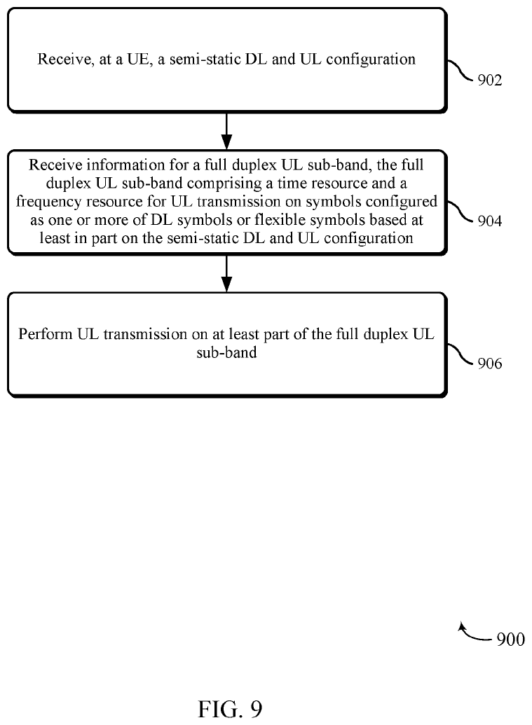

FIG. 9 illustrates a flowchart of a method 900 that supports sub-band based full duplex operation in accordance with aspects of the present disclosure. The operations of the method 900 may be implemented by a device or its components as described herein. For example, the operations of the method 900 may be performed by UE 104 as described with reference to FIGS. 1 through 5b. In some implementations, the device may execute a set of instructions to control the function elements of the device to perform the described functions. Additionally, or alternatively, the device may perform aspects of the described functions using special-purpose hardware.

At 902, the method may include receiving, at a UE, a semi-static DL and UL configuration. The operations of 902 may be performed in accordance with examples as described herein. In some implementations, aspects of the operations of 902 may be performed by a device as described with reference to FIG. 1.

At 904, the method may include receiving information for a full duplex UL sub-band, the full duplex UL sub-band comprising a time resource and a frequency resource for UL transmission on symbols configured as one or more of DL symbols or flexible symbols based at least in part on the semi-static DL and UL configuration. The operations of 904 may be performed in accordance with examples as described herein. In some implementations, aspects of the operations of 904 may be performed by a device as described with reference to FIG. 1.

At 906, the method may include performing UL transmission on at least part of the full duplex UL sub-band. The operations of 906 may be performed in accordance with examples as described herein. In some implementations, aspects of the operations of 906 may be performed by a device as described with reference to FIG. 1.

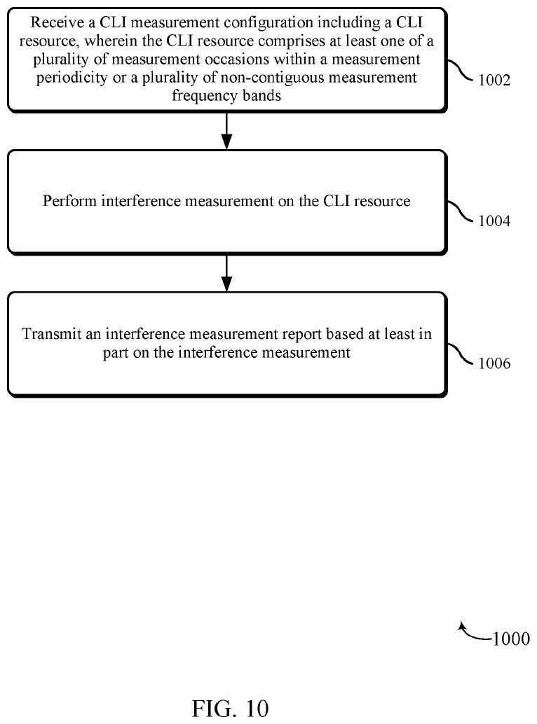

FIG. 10 illustrates a flowchart of a method 1000 that supports sub-band based full duplex operation in accordance with aspects of the present disclosure. The operations of the method 1000 may be implemented by a device or its components as described herein. For example, the operations of the method 1000 may be performed by a UE 104 as described with reference to FIGS. 1 through 5b. In some implementations, the device may execute a set of instructions to control the function elements of the device to perform the described functions. Additionally, or alternatively, the device may perform aspects of the described functions using special-purpose hardware.

At 1002, the method may include receiving a CLI measurement configuration including a CLI resource, wherein the CLI resource comprises at least one of a plurality of measurement occasions within a measurement periodicity or a plurality of non-contiguous measurement frequency bands. The operations of 1002 may be performed in accordance with examples as described herein. In some implementations, aspects of the operations of 1002 may be performed by a device as described with reference to FIG. 1.

At 1004, the method may include performing interference measurement on the CLI resource. The operations of 1004 may be performed in accordance with examples as described herein. In some implementations, aspects of the operations of 1004 may be performed by a device as described with reference to FIG. 1.

At 1006, the method may include transmitting an interference measurement report based at least in part on the interference measurement. The operations of 1006 may be performed in accordance with examples as described herein. In some implementations, aspects of the operations of 1006 may be performed by a device as described with reference to FIG. 1.

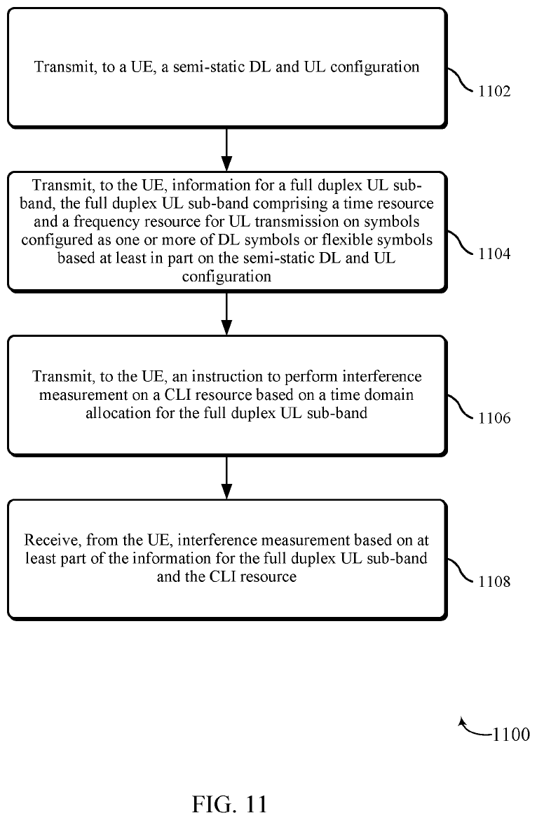

FIG. 11 illustrates a flowchart of a method 1100 that supports sub-band based full duplex operation in accordance with aspects of the present disclosure. The operations of the method 1100 may be implemented by a device or its components as described herein. For example, the operations of the method 1100 may be performed by a network entity 102 as described with reference to FIGS. 1 through 5b. In some implementations, the device may execute a set of instructions to control the function elements of the device to perform the described functions. Additionally, or alternatively, the device may perform aspects of the described functions using special-purpose hardware.

At 1102, the method may include transmitting, to a UE, a semi-static DL and UL configuration. The operations of 1102 may be performed in accordance with examples as described herein. In some implementations, aspects of the operations of 1102 may be performed by a device as described with reference to FIG. 1.

At 1104, the method may include transmitting, to the UE, information for a full duplex UL sub-band, the full duplex UL sub-band comprising a time resource and a frequency resource for UL transmission on symbols configured as one or more of DL symbols or flexible symbols based at least in part on the semi-static DL and UL configuration. The operations of 1104 may be performed in accordance with examples as described herein. In some implementations, aspects of the operations of 1104 may be performed by a device as described with reference to FIG. 1.

At 1106, the method may include transmitting, to the UE, an instruction to perform interference measurement on a CLI resource based on a time domain allocation for the full duplex UL sub-band. The operations of 1106 may be performed in accordance with examples as described herein. In some implementations, aspects of the operations of 1106 may be performed by a device as described with reference to FIG. 1.

At 1108, the method may include receiving, from the UE, interference measurement based on at least part of the information for the full duplex UL sub-band and the CLI resource. The operations of 1108 may be performed in accordance with examples as described herein. In some implementations, aspects of the operations of 1108 may be performed by a device as described with reference to FIG. 1.

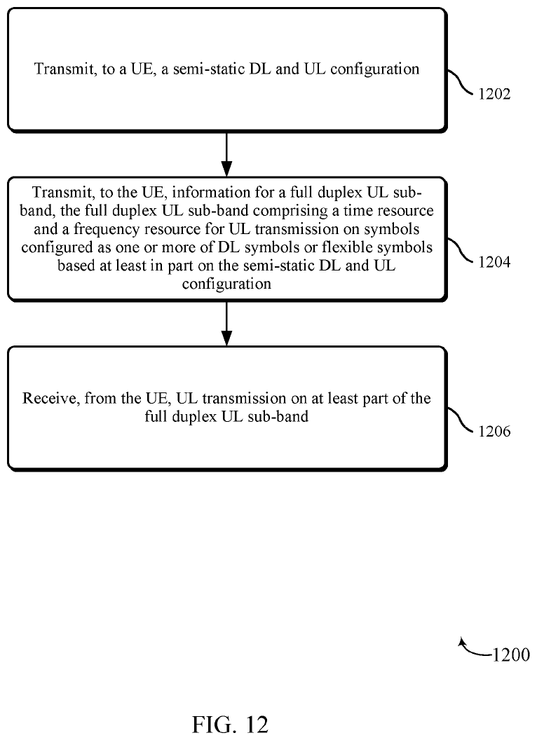

FIG. 12 illustrates a flowchart of a method 1200 that supports sub-band based full duplex operation in accordance with aspects of the present disclosure. The operations of the method 1200 may be implemented by a device or its components as described herein. For example, the operations of the method 1200 may be performed by a network entity 102 as described with reference to FIGS. 1 through 5b. In some implementations, the device may execute a set of instructions to control the function elements of the device to perform the described functions. Additionally, or alternatively, the device may perform aspects of the described functions using special-purpose hardware.

At 1202, the method may include transmitting, to a UE, a semi-static DL and UL configuration. The operations of 1202 may be performed in accordance with examples as described herein. In some implementations, aspects of the operations of 1202 may be performed by a device as described with reference to FIG. 1.

At 1204, the method may include transmitting, to the UE, information for a full duplex UL sub-band, the full duplex UL sub-band comprising a time resource and a frequency resource for UL transmission on symbols configured as one or more of DL symbols or flexible symbols based at least in part on the semi-static DL and UL configuration. The operations of 1204 may be performed in accordance with examples as described herein. In some implementations, aspects of the operations of 1204 may be performed by a device as described with reference to FIG. 1.

At 1206, the method may include receiving, from the UE, UL transmission on at least part of the full duplex UL sub-band. The operations of 1206 may be performed in accordance with examples as described herein. In some implementations, aspects of the operations of 1206 may be performed by a device as described with reference to FIG. 1.

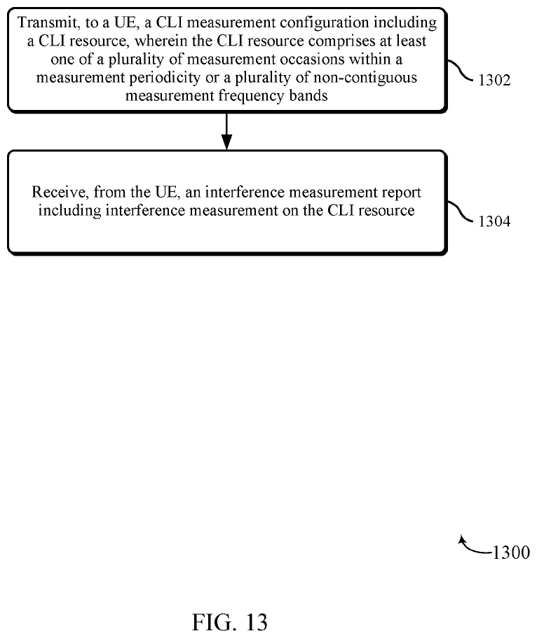

FIG. 13 illustrates a flowchart of a method 1300 that supports sub-band based full duplex operation in accordance with aspects of the present disclosure. The operations of the method 1300 may be implemented by a device or its components as described herein. For example, the operations of the method 1300 may be performed by a network entity 102 as described with reference to FIGS. 1 through 5b. In some implementations, the device may execute a set of instructions to control the function elements of the device to perform the described functions. Additionally, or alternatively, the device may perform aspects of the described functions using special-purpose hardware.

At 1302, the method may include transmitting, to a UE, a CLI measurement configuration including a CLI resource, wherein the CLI resource comprises at least one of a plurality of measurement occasions within a measurement periodicity or a plurality of non-contiguous measurement frequency bands. The operations of 1302 may be performed in accordance with examples as described herein. In some implementations, aspects of the operations of 1302 may be performed by a device as described with reference to FIG. 1.

At 1304, the method may include receiving, from the UE, an interference measurement report including interference measurement on the CLI resource. The operations of 1304 may be performed in accordance with examples as described herein. In some implementations, aspects of the operations of 1304 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a semi-static downlink (DL) and uplink (UL) configuration;
receive information for a full duplex UL sub-band, the full duplex UL sub-band comprising a time resource and a frequency resource for UL transmission on symbols configured as one or more of DL symbols or flexible symbols based at least in part on the semi-static DL and UL configuration; and
perform interference measurement based on at least part of the information for the full duplex UL sub-band.

2. The UE of claim 1, wherein the information for the full duplex UL sub-band comprises at least a time-domain allocation and a frequency-domain allocation.

3. The UE of claim 1, wherein the information for the full duplex UL sub-band further comprises one or more UL configurations, and wherein the one or more UL configurations comprise at least one of physical uplink shared channel (PUSCH), physical uplink control channel (PUCCH), configured grant (CG) PUSCH, sounding reference signal (SRS), or random access channel (RACH) configuration.

4. The UE of claim 3, wherein the one or more UL configurations are indicated by a bandwidth part identity.

5. The UE of claim 4, wherein subcarrier spacing of the full duplex UL sub-band is further determined based on the bandwidth part identity.

6. The UE of claim 4, wherein a cyclic prefix type of the full duplex UL sub-band is further determined based on the bandwidth part identity.

7. The UE of claim 1, wherein the at least one processor is configured to cause the UE to receive a cross-link interference (CLI) measurement configuration including a CLI resource.

8. The UE of claim 7, wherein to perform the interference measurement, the at least one processor is configured to cause the UE to perform the interference measurement on the CLI resource based on a time domain allocation for the full duplex UL sub-band.

9. The UE of claim 7, wherein the CLI measurement configuration comprises a plurality of measurement occasions within a measurement periodicity.

10. The UE of claim 9, wherein each of the plurality of measurement occasions corresponds to a set of symbols of a respective measurement slot of a plurality of measurement slots.

11. The UE of claim 7, wherein to perform the interference measurement, the at least one processor is configured to cause the UE to perform the interference measurement on the CLI resource based on a frequency domain allocation for the full duplex UL sub-band.

12. The UE of claim 11, wherein one or more resource elements of the CLI resource overlapping in frequency with the full duplex UL sub-band are not included for the interference measurement.

13. The UE of claim 7, wherein the CLI measurement configuration comprises a plurality of measurement frequency bands.

14. A user equipment (UE) for wireless communication, comprising:
at least one memory; and
at least one processor coupled with the at least one memory and configured to cause the UE to:
receive a semi-static downlink (DL) and uplink (UL) configuration;
receive information for a full duplex UL sub-band, the full duplex UL sub-band comprising a time resource and a frequency resource for UL transmission on symbols configured as one or more of DL symbols or flexible symbols based at least in part on the semi-static DL and UL configuration; and
perform UL transmission on at least part of the full duplex UL sub-band.

15. The UE of claim 14, wherein the information for the full duplex UL sub-band comprises at least a time-domain allocation and a frequency-domain allocation.

16. The UE of claim 14, wherein the information for the full duplex UL sub-band further comprises one or more UL configurations, wherein the one or more UL configurations comprise at least one of physical uplink shared channel (PUSCH), physical uplink control channel (PUCCH), configured grant (CG) PUSCH, sounding reference signal (SRS), or random access channel (RACH) configuration, and wherein the UL transmission is performed based on the one or more UL configurations.

17. The UE of claim 14, wherein the one or more UL configurations are indicated by a bandwidth part identity.

18. The UE of claim 17, wherein subcarrier spacing of the full duplex UL sub-band is further determined based on the bandwidth part identity.

19. (canceled)

20. A network entity for wireless communication, comprising:
at least one memory; and
at least one processor coupled with the at least one memory and configured to cause the network entity to:
transmit, to a user equipment (UE), a semi-static downlink (DL) and uplink (UL) configuration;
transmit, to the UE, information for a full duplex UL sub-band, the full duplex UL sub-band comprising a time resource and a frequency resource for UL transmission on symbols configured as one or more of DL symbols or flexible symbols based at least in part on the semi-static DL and UL configuration; and
receive, from the UE, interference measurement based on at least part of the information for the full duplex UL sub-band.

21. A processor for wireless communication, comprising:
at least one controller coupled with at least one memory and configured to cause the processor to:
receive a semi-static downlink (DL) and uplink (UL) configuration;
receive information for a full duplex UL sub-band, the full duplex UL sub-band comprising a time resource and a frequency resource for UL transmission on symbols configured as one or more of DL symbols or flexible symbols based at least in part on the semi-static DL and UL configuration; and
perform interference measurement based on at least part of the information for the full duplex UL sub-band.
